(19) United States
(12) Patent Application Publication
(10) Pub. No.: US 2015/0011099 A1
(43) Pub. Date: Jan. 8, 2015

(54) Portable device's protecting case having sliding connector

(71) Applicant: SPS Inc., Daejeon (KR)

(72) Inventors: Hyun Jun Kim, Daejeon (KR); Dae-Young Youn, Seoul (KR); Jung Gyo Kim, Daejeon (KR)

(21) Appl. No.: 14/148,588

(22) Filed: Jan. 6, 2014

(30) Foreign Application Priority Data
Jul. 5, 2013 (KR) 20-2013-0005520

(51) Int. Cl. H01R 13/502; H01R 13/62

(52) U.S. Cl. CPC H01R 13/502; H01R 13/6205
USPC 439/38; 439/347

(57) ABSTRACT

Provided is a portable device's protecting case having a sliding connector, the portable device's protecting case including: a sliding connector 100 capable of reciprocating in a specific direction in the protecting case, wherein the sliding connector 100 is provided with a connector 120 connected to a connection port of the portable device, the connection port of the portable device is electrically connected to a circuit apparatus in the protecting case through the connector 120, and when the sliding connector 100 is pushed to the central direction of the protecting case in a state in which the portable device is inserted into the protecting case, the connector 120 and the connection port of the portable device are connected to each other.

### CROSS-REFERENCE TO RELATED APPLICATIONS

This application claims priority under 35 U.S.C. §119 to Korean Utility model Application No. 20-2013-0005020, filed on Jul. 5, 2013, in the Korean Intellectual Property Office, the disclosure of which is incorporated herein by reference in its entirety.

### TECHNICAL FIELD

The following disclosure relates to a portable device's protecting case having a sliding connector, and more particularly, to a portable device's protecting case having a sliding connector in which a connector of the portable device's protecting case is manufactured in a sliding structure so as to be easily connected to the portable device.

### BACKGROUND

As a smart phone, a tablet PC, and the like have propagated, the above-mentioned portable device's protecting cases have been widely used. However, these protecting cases often house a separate electronic circuit or electrical circuit (hereinafter, referred to as ‘circuit apparatus’) in order to have a function supplying power by housing an auxiliary battery or a function wirelessly transmitting power, in addition to a function simply protecting the portable device from impact. In this case, in order to wire-connect the circuit apparatus and a mobile phone to each other, a connector is often included in the case.

An example of the portable device's protecting case includes a mobile phone case.

FIG. 1 is a perspective view of a mobile phone case 1 according to the related art. A mobile phone 20 may be inserted into an upper part of the mobile phone case 10. The mobile phone case 10 is comprised of a body 12 and a connector 18 protruded from a portion of the body. When the mobile phone 20 is inserted into an upper surface of the mobile phone case 10, the connector 18 of the mobile phone case 10 is inserted into a micro USB port 28 of the mobile phone 20, thereby making it possible to wire-connect the mobile phone 20 and the circuit apparatus in the body 12 of the mobile phone case 10 to each other. In this case, in order to easily insert the connector 18 of the mobile phone case 10 into the micro USB port 28 of the mobile phone 20, the body 12 of the mobile phone case 10 is manufactured by an elastic material so as to be bent to some degree. However, even though the body 12 of the mobile phone case 10 is manufactured by the elastic material, it is not easy to insert the connector 18 of the mobile phone case 10 into the micro USB port 28 of the mobile phone 20.

In order to solve the above-mentioned problem, a mobile phone case (hereinafter, referred to as “mobile phone case 2 according to the related art’) described in U.S. Pat. No. 8,367,235 B2 (issue date: Feb. 5, 2013) has a body of a mobile phone case formed so as to be separated.

FIG. 2 is a perspective view of a mobile phone case 2 according to the related art. The body of the mobile phone case is comprised of a lower side body part 14 and an upper side body part 16, where the lower side body part 14 and the upper side body part 16 are formed so as to be removable from each other. The lower side body part 14 is provided with the connector 18. The connector 18 is inserted into the micro USB port 28 of the mobile phone 20 by sliding the mobile phone 20 into the lower side body part 14, and the upper side body part 16 is then coupled to the lower side body part 14. The mobile phone case 2 according to the related art may easily insert the connector 18 of the mobile phone case 10 into the micro USB port 28 of the mobile phone 20. However, since the body of the mobile phone case is separated into two parts, rigid is low and there is a risk of missing the upper side body part

### SUMMARY

An embodiment of the present invention is directed to providing a portable device's protecting case capable of easily inserting a connector of the portable device's protecting case into a portable device's port and having a body of a mobile phone device's protecting case which is integrally formed.

In one general aspect, a portable device's protecting case having a sliding connector includes: a sliding connector 100 capable of reciprocating in a specific direction in the protecting case, wherein the sliding connector 100 is provided with a connector 120 connected to a connection port of the portable device, the connection port of the portable device is electrically connected to a circuit apparatus in the protecting case through the connector 120, and when the sliding connector 100 is pushed to the central direction of the protecting case in a state in which the portable device is inserted into the protecting case, the connector 120 and the connection port of the portable device are connected to each other.

The sliding connector 100 may have a protrusion part 130 formed at a side of a body part 110 thereof, where the protrusion part 130 may limit a movable range of the sliding connector 100.

The sliding connector 100 may have a body part hole 140 formed at side of a body part 110 thereof.

The sliding connector 100 may have a plurality of pin terminals 160 formed at a side of a body part thereof.

The sliding connector 100 may have a plurality of electrodes formed at a side of a body part 110 thereof, where the plurality of electrodes may be formed to be long in a reciprocating direction of the sliding connector.

The sliding connector 100 may have a port formed at a body part 110 thereof, the port 180 being connected to an external connector.

The circuit apparatus may include a battery supplying power to a mobile phone in a case of power shortage of the mobile phone.

The circuit apparatus may include a power receiving coil for wirelessly transmitting power and a circuit converting a voltage of power received from the coil into a specific voltage.

The circuit apparatus may include an electrode pattern for a magnetic connector.

Other features and aspects will be apparent from the following detailed description, the drawings, and the claims.

### BRIEF DESCRIPTION OF THE DRAWINGS

FIG. 1 is a perspective view of a mobile phone case 1 according to the related art.

FIG. 2 is a perspective view of a mobile phone case 2 according to the related art.

FIGS. 3A and 3B are plane views of a mobile phone case according to an exemplary embodiment of the present invention.

FIGS. 4A to 4C are cross-sectional views of a use state of a sliding connector according to an exemplary embodiment of the present invention.

FIG. 5 is a perspective view of a sliding connector having a hole formed at a side thereof.

FIG. 6 is a cross-sectional view of a use state of the sliding connector having the hole formed at the side thereof.

FIG. 7 is a perspective view of a sliding connector having a pin terminal formed at a side thereof.

FIGS. 8A and 8B show configurations in which the pin terminal of the sliding connector contacts an electrode of the mobile phone case.

FIG. 9 is a cross-sectional view of a use state of the sliding connector having the pin terminal formed at the side thereof.

FIG. 10 is a perspective view of a sliding connector having a micro USB port formed at a lower portion thereof.

FIGS. 11A and 11B are perspective views of a mobile phone case according to another exemplary embodiment of the present invention.

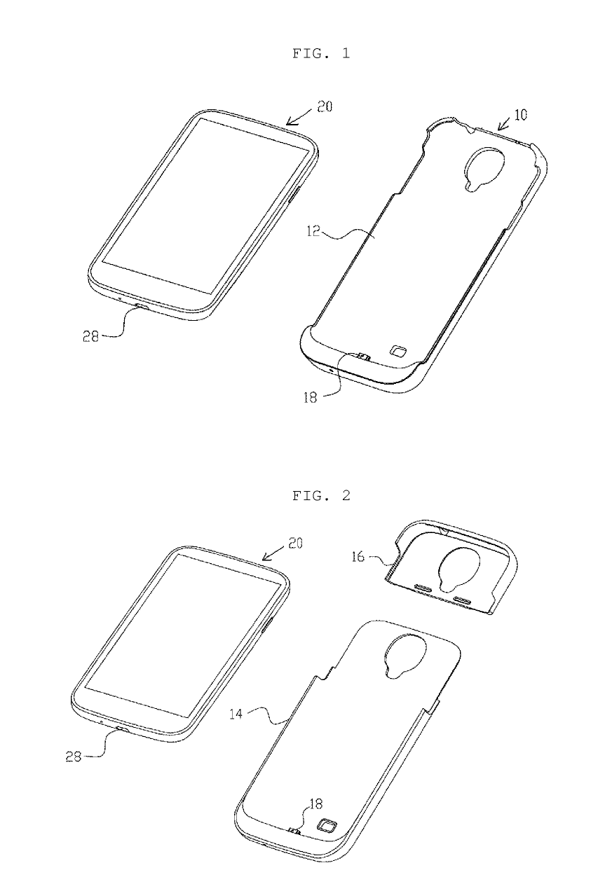

[Detailed Description of Main Elements]

| | |
|---|---|
| 100: sliding connector | 110: body part |
| 120: USB connector | 130: protrusion part |
| 140: body part hole | 150: wire |
| 155: circuit apparatus | 160: pin terminal |
| 170: pin terminal hole | 180: connector side micro USB port |
| 200: mobile phone case body | |
| 210: movement limit step | 220: case hole |
| 240: electrode | |

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

Hereinafter, a portable device's protecting case having a sliding connector according to an exemplary embodiment of the present invention will be described in more detail with reference to the accompanying drawings.

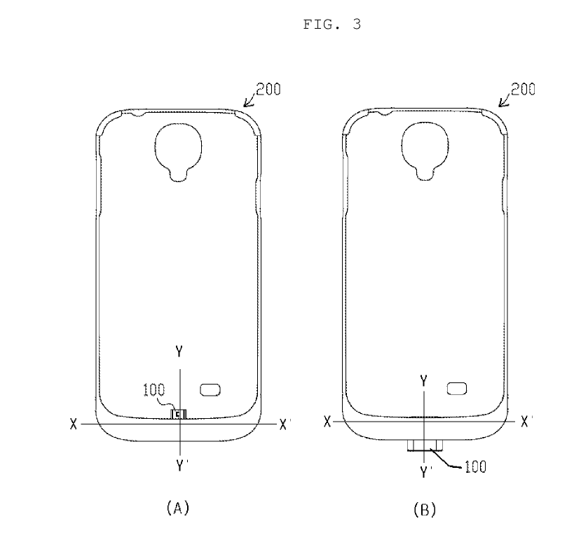

FIGS. 3A and 3B are plane views of a mobile phone case according to an exemplary embodiment of the present invention. FIG. 3A is a configuration of a case in which a sliding connector 100 is upwardly pushed and FIG. 3B is a configuration of a case in which the sliding connector 100 is downwardly pushed.

As shown in FIGS. 3A and 3B, in the case in which the sliding connector 100 has a structure in which it may reciprocate in a body 200 of the mobile phone case, a mobile phone may be easily inserted into the mobile phone case.

First, in the case in which the sliding connector 100 is positioned at a position of FIG. 3A, the sliding connector 100 may be pushed with a finger so as to be positioned at a position of FIG. 3B. Thereafter, when the mobile phone is inserted into the mobile phone case and the sliding connector 100 is then inwardly pushed with the finger, a micro USB connector portion of the sliding connector 100 is inserted into the micro USB port of the mobile phone.

When separating the mobile phone from the mobile phone case, since the mobile phone case has slight elasticity, the mobile phone is easily separated from the mobile phone case in a case of separating the mobile phone from an upper part of the mobile phone case.

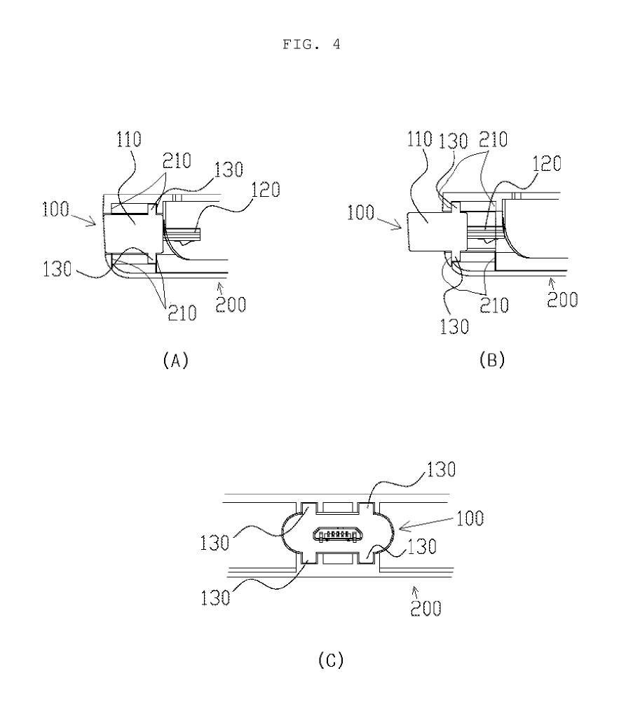

FIGS. 4A to 4C are cross-sectional views of a use state of a sliding connector according to an exemplary embodiment of the present invention.

FIG. 4A is a cross-sectional view taken along a direction line Y-Y′ of FIG. 3A, FIG. 4B is a cross-sectional view taken along a direction Y-Y′ of FIG. 3B, and FIG. 4C is a cross-sectional view taken along a direction X-X′ of FIG. 3A.

The sliding connector 100 according to the exemplary embodiment of the present invention is configured by a body part 110, a micro USB connector 120, and four protrusion parts 130 formed at a side of the body part 110. An upper surface of the body part 110 (a surface toward the center of the mobile phone case) is provided with the micro USB connector 120, and the micro USB connector 120 may be inserted into the micro USB port of the mobile phone. The body 200 of the mobile phone case is provided with a movement limit step 210 to thereby limit a range in which the four protrusion parts 130 may be moved, such that a movable range of the sliding connector 100 may also be limited. The sliding connector 100 may reciprocate in a specific direction in the protecting case. The number of protrusion parts 130 is not necessarily four, and may be implemented to be changed to a necessary number, if necessary.

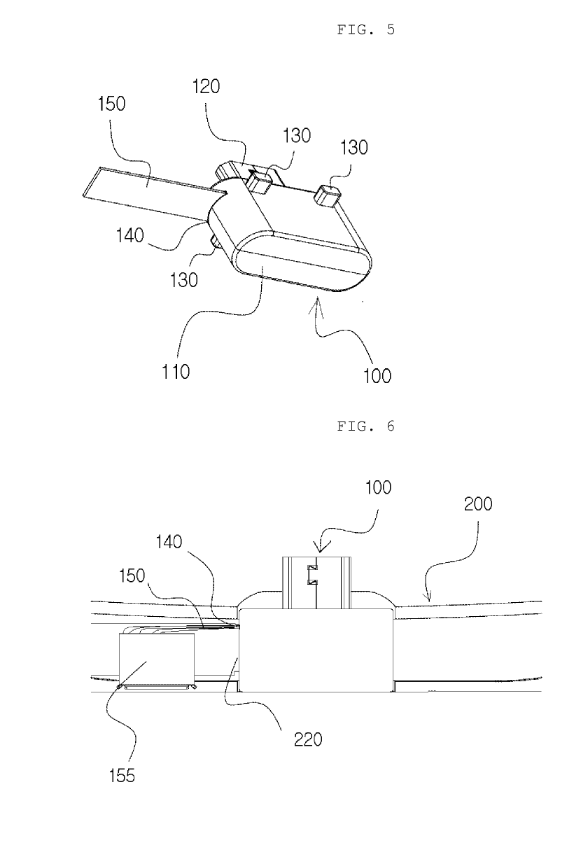

FIG. 5 is a perspective view of a sliding connector having a hole formed at a side thereof and FIG. 6 is a cross-sectional view of a use state of the sliding connector having the hole formed at the side thereof.

A side of the body part 110 of the sliding connector 100 is provided with a body part hole (opening) 140. In addition, a position corresponding to the body part hole 140 in the body 200 of the mobile phone case is provided with a case hole 220. A wire 150 connected to the micro USB connector 120 is connected to a circuit apparatus 155 in the mobile phone case through the body part hole 140 and the case hole 220. The circuit apparatus 155 may include various components such as a USB port, a battery, and the like.

The body part hole 140 or the case hole 220 needs to be sufficiently long in a vertical direction as much as a space through which the wire 150 passes even though the sliding connector 100 is upwardly and downwardly moved.

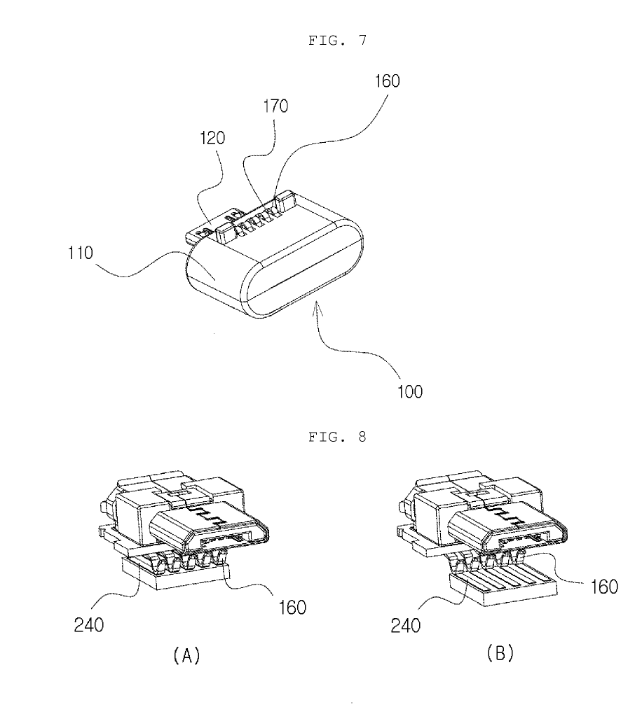

The wire extended from the micro USB connector 120 and the circuit apparatus 155 in the mobile phone case may be directly connected to each other by the wire 150 as shown in FIGS. 5 and 6, but may be connected to each other through the contact between the electrode and the pin terminal as shown in FIGS. 7 to 9.

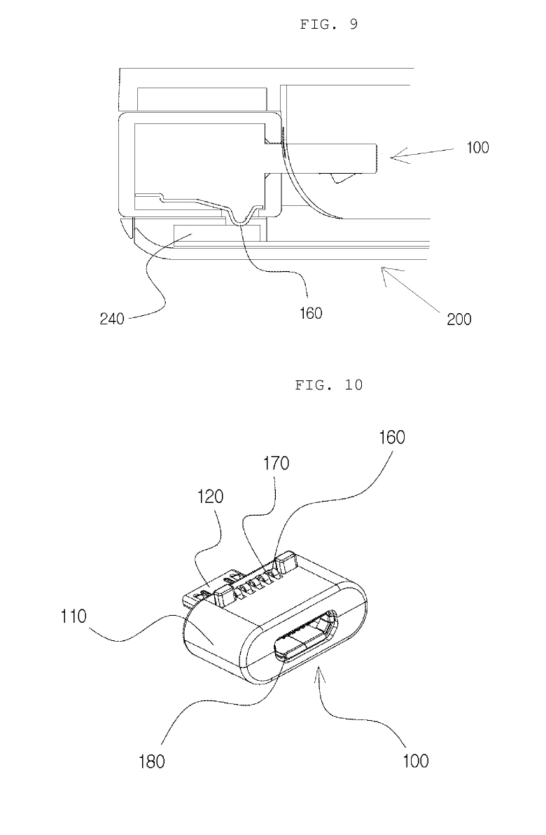

FIG. 7 is a perspective view of a sliding connector having a pin terminal formed at a side thereof, FIGS. 8A and 8B show configurations in which the pin terminal of the sliding connector contacts an electrode of the mobile phone case, and FIG. 9 is a cross-sectional view of a use state of the sliding connector having the pin terminal formed at the side thereof. FIG. 8A is a configuration of a case in which the sliding connector is moved to a direction in which the mobile phone is present and FIG. 8B is a configuration of a case in which the sliding connector is moved to a direction opposite to the direction in which the mobile phone is present.

As shown in FIG. 7, the body part 110 of the sliding connector 100 has a plurality of pin terminals 160 formed at a side thereof, and the wire extended from the micro USB connector 120 passes through an inner portion of the sliding connector 100 to thereby be connected to the plurality of pin terminals 160. In addition, positions corresponding to the plurality of pin terminals 160 in the body 200 of the mobile phone case are provided with a plurality of electrodes 240 to be long in the vertical direction. The plurality of pin terminals 160 and the plurality of electrodes 240 maintain contact with each other by elasticity of the pin terminals 160.

In order to form an elastic structure, a structure using a cylindrical pin terminal and a coil type spring may be used, but a plate type spring or a line type spring may be used to implement miniaturization.

After the pin terminal 160 having a thin and long rectangular shape is bent to thereby manufacture the plate type spring so as to have a shape such as the pin terminal 160 of FIG. 8, a structure in which the above-mentioned plate type spring is closely adhered to a pin terminal hole 170 may be manufactured. So doing, a protruded portion of the plate type spring is exposed to the pin terminal hole 170 and the pin terminal 160 may maintain contact with the plurality of electrodes 240 by elasticity.

The electrode 240 needs to be sufficiently long in a vertical direction so that the pin terminal 160 and the electrode 240 may maintain contact with each other even though the sliding connector 100 is upwardly and downwardly moved.

In the case in which a width of the plate type spring becomes very narrow while maintaining a side view of the plate type spring so as to become a shape such as the pin terminal 160 of FIG. 8, the spring becomes the line type spring. When the line type spring is used in implementing the elastic structure, the pin terminal may be advantageously lightened and miniaturized.

The pin terminals 160 may be formed at only one side of the body 110 of the sliding connector 100, but may be formed at both sides of the body 110 of the sliding connector 100. In the case in which the pin terminals 160 are formed at both sides of the body 110 of the sliding connector 100, since the number of pin terminals 160 to be formed at one side is decreased to half, a thickness of the sliding connector 100 may be decreased. In the case in which the pin terminals 160 are formed at four direction sides of the body 110 of the sliding connector 100, since the number of electrodes 240 to be formed at one side is further decreased, a size of the sliding connector 100 may be further decreased.

Although the above exemplary embodiment shows a case in which the pin terminals 160 are formed on a side of the sliding connector 100 and the electrodes 240 are formed on a side of the body 200 of the mobile phone case, it is possible to implement a case in which the electrodes are formed on a side of the sliding connector 100 and the pin terminals are formed on a side of the body 200 of the mobile phone case.

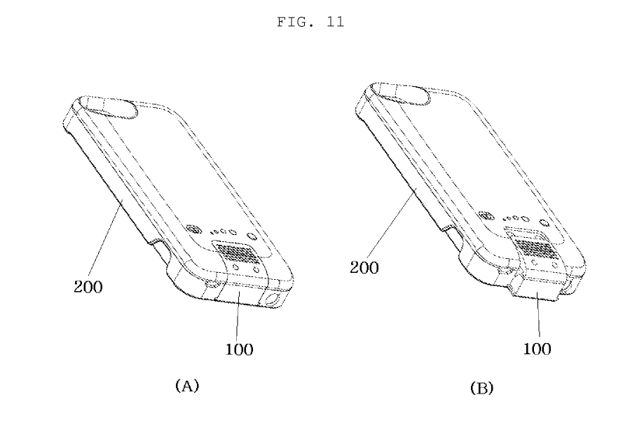

FIG. 10 is a perspective view of a sliding connector having a micro USB port formed at a lower portion thereof. A lower surface of the sliding connector 100 of FIG. 10 is provided with a connector side micro USB port 180. Therefore, an external connector having a standard capable of being inserted into the micro USB port of the mobile phone may be inserted into the connector side micro USB port 180.

Using the sliding connector of FIG. 10, it is possible to design an internal electronic circuit of the mobile phone case 100 so that an operation thereof is changed depending on whether or not the external connector is connected.

For example, it is possible to design the internal electronic circuit so that when the external connector is not connected, power is supplied from an auxiliary battery in the circuit apparatus in the body 200 of the mobile phone case to the mobile phone, and when the external connector is connected, power is supplied from the external connector to the mobile phone and the auxiliary battery in the mobile phone case.

Although there are many exemplary embodiments in which the operation of the internal electronic circuit of the mobile phone case 100 is changed depending on whether or not the external connector is connected other than those mentioned above, since these exemplary embodiments are not directly related to a technical idea of the present invention, a detail description thereof will be omitted.

The circuit apparatus in the body 200 of the mobile phone case includes various examples. For example, the circuit apparatus may be a battery inserted into the mobile phone case and a circuit supplying power of the battery to the mobile phone in a case of power shortage of the mobile phone. Alternatively, the circuit apparatus may be a power receiving coil for wirelessly transmitting power and a circuit converting a voltage of power received from the coil into a specific voltage to supply it to the mobile phone. Alternatively, an electrode pattern for a magnetic connector may be formed on a surface of the mobile phone case and a wire electrically connecting the micro USB port of the mobile phone to the electrode pattern may be formed in the mobile phone case. Here, ‘the electrode pattern for the magnetic connector’ means a structure in which a plurality of electrodes are formed at a portion forming one side connector of the magnetic connector.

Although the exemplary embodiments shown in FIGS. 3 to 10 show a structure in which it is difficult to pull the sliding connector 100 to the outside of the body 200 of the mobile phone case since the sliding connector 100 is not exposed to the outside when the sliding connector 100 is pushed into an inside of the body 200 of the mobile phone case, it is possible to easily pull the sliding connector 100 to the outside of the body 200 of the mobile phone case by increasing an exposed portion of the sliding connector 100.

FIGS. 11A and 11B are perspective views of a mobile phone case according to another exemplary embodiment of the present invention. FIG. 11A is a perspective view of a state in which the sliding connector 100 is pushed into an inside of the body 200 of the mobile phone case and FIG. 11B is a perspective view of a state in which the sliding connector 100 is pulled to the outside of the body 200 of the mobile phone case.

In the mobile phone case of FIGS. 11A and 11B, since a side of the sliding connector 100 is exposed to a side of the body 200 of the mobile phone case, the side of the sliding connector 100 is pulled with the hand even in the state of FIG. 11A, thereby easily manipulating the sliding connector 100 to be become the state of FIG. 11B.

Although the above-mentioned exemplary embodiments describe the mobile phone's protecting case (mobile phone case) by way of example, the same technology may be applied to a tablet PC's protecting case other than the mobile phone and the same technology may be applied to other portable device's protecting cases.

In addition, although the above-mentioned exemplary embodiments describe only a case in which the micro USB port is formed at the mobile phone and the micro USB connector is formed at the mobile phone case by way of example, the same technology may also be applied to a case in which other kinds of connection ports are formed at the portable device and other kinds of connectors are formed at the protecting case.

In the portable device's protecting case having a sliding connector according to the exemplary embodiment of the present invention, the connector of the portable device's protecting case may be easily inserted into the portable device's port and the body of the mobile phone device's protecting case is integrally formed, such that the portable device's protecting case is rigid and there is no risk of missing thereof.

What is claimed is:

1. A portable device's protecting case having a sliding connector, the portable device's protecting case comprising:
a sliding connector capable of reciprocating in a specific direction in the protecting case,
wherein the sliding connector is provided with a connector connected to a connection port of the portable device,
the connection port of the portable device is electrically connected to a circuit apparatus in the protecting case through the connector, and
when the sliding connector is pushed to the central direction of the protecting case in a state in which the portable device is inserted into the protecting case, the connector and the connection port of the portable device are connected to each other.

2. The portable device's protecting case of claim 1, wherein the sliding connector has a protrusion part formed at a side of a body part thereof, the protrusion part limiting a movable range of the sliding connector.

3. The portable device's protecting case of claim 1, wherein the sliding connector has a body part hole formed at a side of a body part thereof.

4. The portable device's protecting case of claim 1, wherein the sliding connector has a plurality of pin terminals formed at a side of a body part thereof.

5. The portable device's protecting case of claim 1, wherein the sliding connector has a plurality of electrodes formed at a side of a body part thereof, the plurality of electrodes being formed to be long in a reciprocating direction of the sliding connector.

6. The portable device's protecting case of claim 1, wherein the sliding connector has a port formed at a body part thereof, the port being connected to an external connector.

7. The portable device's protecting case of claim 1, wherein the circuit apparatus includes a battery supplying power to a mobile phone in a case of power shortage of the mobile phone.

8. The portable device's protecting case of claim 1, wherein the circuit apparatus includes a power receiving coil for wirelessly transmitting power and a circuit converting a voltage of power received from the coil into a specific voltage.

9. The portable device's protecting case of claim 1, wherein the circuit apparatus includes an electrode pattern for a magnetic connector.
